(19) United States
(12) Patent Application Publication
(10) Pub. No.: US 2026/0259547 A1
(43) Pub. Date: Sep. 3, 2026

(54) MOTION CONTROLLER APPARATUS AND METHOD OF OPERATION THEREFOR

(71) Applicant: EasyCMM Ltd, Kadima Tzoran (IL)

(72) Inventors: Eran YERUHAM, Tel Mond (IL); David BUNIMOVICH, Kadima Tzoran (IL)

(21) Appl. No.: 18/876,096

(22) PCT Filed: Mar. 28, 2023
(86) PCT No.: PCT/IL2023/050322

§ 371 Date: Dec. 17, 2024

Related U.S. Application Data
(60) Provisional application No. 63/359,233, filed on Jul. 8, 2022.

(30) Foreign Application Priority Data
Sep. 6, 2022 (IL) 296272

(51) Int. Cl. G05B 19/4155; G05B 19/408; G05B 19/414

(52) U.S. Cl. CPC G05B 19/4155; G05B 19/4083; G05B 19/4148

(57) ABSTRACT

A controller apparatus configured for communication with a client workstation and electrical connection with a frame for either replacing an inoperable motion controller in an existing CMM system or customizing a new CMM system. The motion controller apparatus includes an interpretation module and a motion controller. The interpretation module is configured for interpreting MPPE native motion controller commands, namely, not I++ motion controller commands, to motion controller commands and motion controller feedback messages, namely, not I++ motion controller feedback messages, to MPPE native motion controller feedback messages. The motion controller is configured for parsing motion controller commands and motion controller feedback messages for executing a part inspection program on a frame irrespective of its frame vendor.

### FIELD OF THE INVENTION

The invention relates to metrology in general and motion controllers for Coordinate Measuring Machines (CMMs) in particular.

### BACKGROUND OF THE INVENTION

Modern engineered components have more and more non-prismatic features or complex geometric dimensioning and tolerancing (GD&T) that are increasingly difficult to measure without the use of custom inspection equipment or check fixtures. A Coordinate Measuring Machine (CMM) provides an avenue to measure the complex features on many different types of parts without the need for custom tooling.

Coordinate Measuring Machine (CMM) users, for example, automobile manufacturers, sub-contractors providing production services and part inspection services, and the like, have CMM installations ranging from single CMM systems to hundreds of CMM systems. CMM systems have three components: a frame, a motion controller in electrical connection with a frame via a wire harness, and a client workstation in communication with a motion controller. Frames can be a gantry type, a bridge type, an arm type, and the like, and movable in at least two and typically three or more Cartesian and/or polar axes. Client workstations run Measurement Part Program Execution (MPPE) client software. MPPE client software includes a MPPE client software driver set of at least one MPPE client software driver to send motion controller commands to a motion controller and receive motion controller feedback messages therefrom. Motion controllers include motion controller firmware and/or motion controller software for inter alia parsing motion controller commands and motion controller feedback messages. MPPE client software preferably supports full functionality part inspection programs including inter alia unknown scanning functionality.

CMM systems can be controlled either manually to inspect a part or by a part inspection program written by a CMM programmer. Part inspection programs include setup, calibration and execution. CMM programmers can take drawings, diagrams or prototype information and generate a part inspection program to automate a ‘run’ of inspection and data collection. CMM programmers can also set up a part inspection program to perform specific tasks with collected data, for example, creation of reports, comparisons to produce further analysis of a part, integrate with other client workstation software, for example, CAD.

OEM CMM market is supplied by a range of CMM equipment vendors. CMM equipment vendors can be classified into four categories as follows:
CMM system vendors which develop, market and support frames, motion controllers, and MPPE client software. An alphabetical list of CMM system vendors includes inter alia:
Hexagon www.hexagon.com
LKMetrology www.lkmetrology.com
Mitutoyo www.mitutoyo.com
Wenzel-Group www.wenzel-group.com
Zeiss www.zeiss.com
Motion controller vendors which develop, market and support motion controllers. An alphabetical list of motion controller vendors includes inter alia:
Pantec www.pantec.com
Renishaw www.renishaw.com
MPPE client software vendors which develop, market and support MPPE client software. An alphabetical list of MPPE client software vendors and their MPPE client software brands includes inter alia:

| | |
|---|---|
| Autodesk www.autodesk.com | Brand: PowerINSPECT |
| Innovmetric www.innovmetric.com | Brand: PolyWorks |
| Siemens www.siemens.com | Brand: NX CMM |
| TouchDMIS www.touchdmis.com | Brand: TouchDMIS |
| Verisurf www.verisurf.com | Brand: Verisurf |

Some frame manufacturers develop, market and support frames only. Other frame manufacturers, for example, Accurate Sales and Services Pvt, India www.accurateganging.com market CMM systems by integrating their frames with commercially available motion controllers and commercially available MPPE client software.

The CMM aftermarket includes retrofit companies for retrofitting CMM systems particularly in the case of motion controller hardware failures.

CMM system vendors, for example, Mitutoyo, Hexagon, Zeiss, and like, develop, market and support proprietary technologies which are not interoperable to the detriment of CMM users. Accordingly, part inspection programs written in one CMM system vendor's MPPE client software is inoperable with another CMM system vendor's motion controller.

In addition to non-interoperability between equipment of CMM system vendors, availability of replacement motion controllers is sometimes restricted. Accordingly, a CMM system may become redundant because of a motion controller hardware failure and a CMM user may have to replace an entire CMM system or otherwise purchase a replacement motion controller together with a new workstation software license or software license upgrade.

To overcome vendor lock-in both in terms of non-interoperability and replacement motion controllers, a consortium of automobile manufacturers set up a CMM protocol called I++ (Inspection plus-plus). I++ protocol requires CMM system vendors to develop, market and support I++ server software and I++ client software in addition to their MPPE client software. But I++ protocol affords lower metrological functionality than CMM system vendors' proprietary technology. For example, I++ protocol supports unknown scanning functionality to a lesser degree. Moreover, CMM users are required to purchase I++ client software licenses in addition to MPPE client software licenses.

There is a need to afford aftermarket assistance to existing CMM users in the case of motion controller hardware failure. And also assist CMM users to customize new CMM systems as opposed to being restricted to off the shelf complete new CMM systems from a single CMM equipment vendor.

### SUMMARY OF THE INVENTION

The present invention is directed towards motion controller apparatus configured for communication with a client workstation and electrical connection with a frame for either replacing an inoperable motion controller in an existing CMM system or customizing a new CMM system. The motion controller apparatus includes an interpretation module and a motion controller. The interpretation module is configured for interpreting MPPE native motion controller commands, namely, not I++ motion controller commands, to motion controller commands and motion controller feedback messages, namely, not I++ motion controller feedback messages, to MPPE native motion controller feedback messages. The motion controller is configured for parsing motion controller commands and motion controller feedback messages for executing a part inspection program on a frame irrespective of its frame vendor.

The interpretation module of the motion controller apparatus can be designed to interpret MPPE native motion controller commands and MPPE native motion controller feedback messages of a single MPPE client software vendor of the aforementioned list of MPPE client software vendors and preferably its legacy releases. The interpretation module can preferably be designed to interpret a MPPE native motion controller commands and MPPE native motion controller feedback messages of a multitude of MPPE client software vendors of the aforementioned list of MPPE client software vendors. The interpretation module may be implemented in different manners: In one embodiment of the present invention, the interpretation module can be implemented in the motion controller as either firmware or a software module. In another embodiment of the present invention, the interpretation module can be installed as a software module in a client workstation.

The motion controller can be provided with a connection board with all required connectors for being connected to a frame irrespective of its frame vendor. Alternatively, the motion controller can be provided with a vendor specific connection board dedicated to being connected to a frame of a particular CMM system vendor, for example, Mitutoyo, Hexagon, and the like, or a frame vendor only. Further alternatively, the motion controller can be provided with a Renishaw-like connection board. The connection board can be either an external connection board or an internal connection board.

In case of an existing CMM system, the motion controller apparatus of the present invention can replace an inoperable Mitutoyo motion controller, an inoperable Hexagon motion controller, an inoperable Renishaw motion controller, and the like. In the case of customizing a new CMM system, the motion controller apparatus of the present invention enables a CMM user to build a CMM system with MPPE client software and a frame from different CMM equipment vendors. By virtue of the present invention, CMM users can employ a single part inspection program for inspecting a part irrespective of a deployed frame and sensing apparatus.

### BRIEF DESCRIPTION OF DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a combined pictorial representation and block diagram of a Mitutoyo CMM system;

FIG. 2 is a schematic representation of a Mitutoyo motion controller UC200's internal connection board and external connection board;

FIG. 3 is a combined pictorial representation and block diagram of a Hexagon CMM system;

FIG. 4 is a schematic representation of a Hexagon external connection board;

FIG. 5 is a combined pictorial representation and block diagram of a CMM system with Renishaw's UCC Universal CMM controller;

FIG. 6 is a schematic representation of a D-type connector for a motor output and an analog tachometer input in unison;

FIG. 7 is a schematic representation of a Renishaw external connection board;

FIG. 8 is a combined pictorial representation and block diagram of a CMM system with Applicant's EasyCMM™ I++ server software;

FIG. 9 is a combined pictorial representation and block diagram showing the use of Applicant's EasyCMM™ I++ server software to connect a Mitutoyo client workstation with a Hexagon motion controller/frame;

FIG. 10 is a combined pictorial representation and block diagram of one implementation of motion controller apparatus of the present invention;

FIG. 11 is a combined pictorial representation and block diagram of another implementation of motion controller apparatus of the present invention; and

FIG. 12 is a flow diagram of the operation of the motion controller apparatus of the present invention.

### DETAILED DESCRIPTION OF DRAWINGS

### Section 1 Commercially Available CMM Equipment

This section includes the following sub-sections:
1.1 Mitutoyo CMM system
1.2 Hexagon CMM system
1.3 CMM system with Renishaw's UCC Universal CMM Controller
1.4 CMM system with Applicant's EasyCMM™ I++ server

### Section 1.1 Mitutoyo CMM System

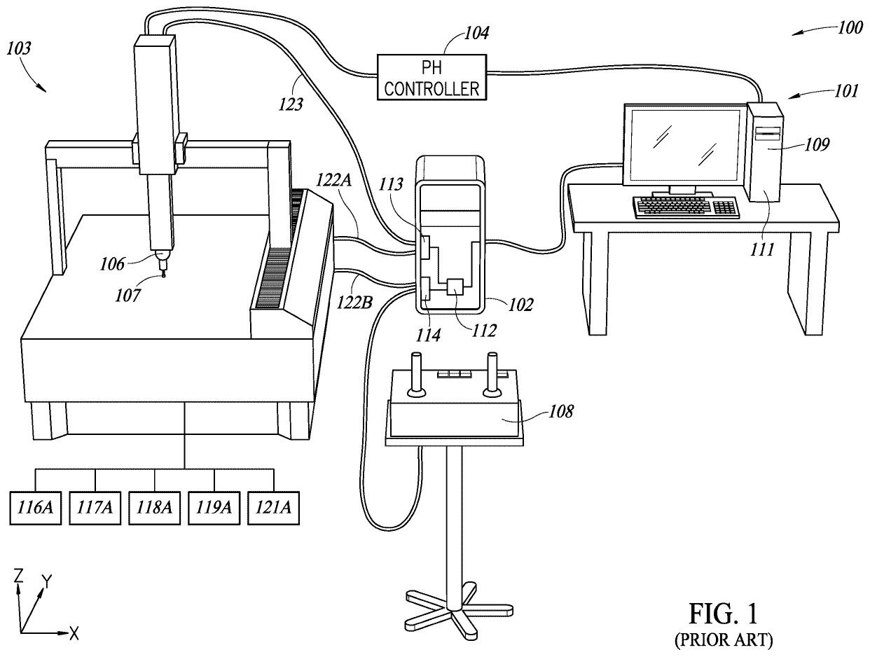

FIG. 1 shows a Mitutoyo CMM system 100 including a Mitutoyo client workstation 101, a Mitutoyo motion controller 102, and a Mitutoyo frame 103, and a Probe Head (PH) controller 104 for positioning a probe head 106 to a Cartesian and/or polar destination along X, Y, and Z frame axes. The Mitutoyo frame 103 is exemplified by a bridge-type frame. The probe head 106 is fitted with interchangeable sensing apparatus 107. The Mitutoyo CMM system 100 includes a joystick 108 for manual operation.

Exemplary Mitutoyo CMM systems 100 include inter alia
1) Crysta APEX https://www.mitutoyo.com/crysta-av/2)
Legex https://www.mitutoyo.com/products/coordinate-measuring-machines/ultra-high-accuracy-coordinate-measuring-machines/legex-500-700-900-1200/

The Mitutoyo client workstation 101 runs Mcosmos MPPE client software 109. The Mcosmos MPPE client software 109 includes one or more Mcosmos driver sets. The present Mcosmos MPPE client software release is Release Version 5.0. The Mitutoyo client workstation 101 stores and executes Mcosmos MPPE part inspection programs 111 for inspecting parts. The Mitutoyo client workstation 101 communicates with the Mitutoyo motion controller 102 over an Arcnet communication network.

Mitutoyo develops, markets and supports Mitutoyo motion controllers 102 which each supports a range of Mitutoyo frames 103. Mitutoyo has developed, marketed and supported a range of Mitutoyo motion controllers 102 starting from UC100. The Mitutoyo motion controller 102 has Mitutoyo firmware and/or motion controller software 112, a Mitutoyo internal connection board 113, and a Mitutoyo external connection board 114. Different Mitutoyo motion controllers 102 have a different Mitutoyo firmware and/or motion controller software 112, a different Mitutoyo internal connection board 113, and a different Mitutoyo external connection board 114.

The Mitutoyo frame 103 includes the following components:
X, Y and Z motors 116A for positioning the probe head 106 along the X, Y and Z frame axes
X, Y, and Z analog linear encoders 117A for position feedback of the probe head 106 along the X, Y and Z frame axes
X, Y and Z digital motor encoders 118A for velocity feedback of the probe head 106 along the X, Y and Z frame axes
I/O (limit switches, emergency stop, air pressure sensor, and the like) 119A
Temperature compensation sensors 121A

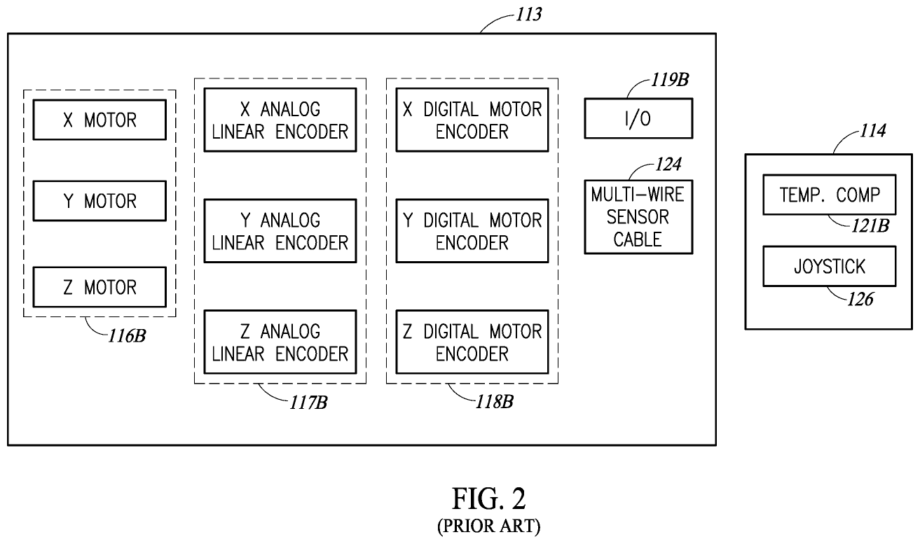

For illustrative purposes, connection of the Mitutoyo frame 103 to a Mitutoyo motion controller 102 is now described with reference to a Mitutoyo motion controller UC200 and FIG. 2 as follows:
The X, Y and Z motors 116A terminate at wire-to-board connectors 116B for connection on the Mitutoyo internal connection board 113
The X, Y, and Z analog linear encoders 117A terminate at wire-to-board connectors 117B for connection on the Mitutoyo internal connection board 113
The X, Y and Z digital motor encoders 118A terminate at wire-to-board connectors 118B for connection on the Mitutoyo internal connection board 113
The I/O 119A terminates at a wire-to-board connector 119B for connection on the Mitutoyo internal connection board 113
The temperature compensation sensors 121A terminate at a D-type connector 121B for connection on the Mitutoyo external connection board 114
The Mitutoyo frame 103 has wire harnesses 122A and 122B corresponding to the Mitutoyo internal connection board 113 and the Mitutoyo external connection board 114
The sensing apparatus 107 has a multi-wire sensor cable 123 terminating at a wire-to-board connector 124 for connection on the Mitutoyo internal connection board 113
The joystick 108 terminates at a D-type connector 126 for connection on the Mitutoyo external connection board 114

Mcosmos MPPE client software 109 is in bidirectional communication with the Mitutoyo motion controller 102 and the probe head controller 104. The Mitutoyo motion controller 102 is in uni- or bi-directional communication with the sensing apparatus 107 depending on the type of sensing apparatus 107. Mcosmos MPPE client software 109 has a predetermined list of MPPE native motion controller commands for executing MPPE part inspection programs, and a predetermined list of MPPE native motion controller feedback messages. MPPE native motion controller feedback messages can be classified into at least three feedback message types as follows: First, motion controller command acknowledgements. Second, I/O feedback messages. And third, sensing apparatus feedback messages. Mcosmos MPPE client software 109 sends hexadecimal Mcosmos MPPE native motion controller commands to the Mcosmos motion controller 102 and receives hexadecimal Mcosmos MPPE motion controller feedback messages therefrom.

An exemplary Mcosmos MPPE native motion controller command PROBE TO for moving the sensing apparatus 107 to X=100, Y=100 and Z=100 and being ready for sensing thereat is:
0x01 0x12 0xE2 0x01 0x04 0x00 0x00
0x00 0x00 0x00 0x64
0x00 0x00 0x00 0x64
0x00 0x00 0x00 0x64
0x00 0x00 0x00 0x00
0x00 0x00 0x00 0x00
0x00 0x00 0x36 0x65 0xc4
and its Mcosmos MPPE native motion controller feedback message is: 0x00 0x00 0x00 0x25 Oxde 0x72 0x00 0xb9 Oxce 0xf3 0x00 0x3f 0xbb 0x4d 0x00 0xa3 0x0d 0x4a 0xd7 0xa3 0x0d 0x4a 0xd7 0x1b 0xbc 0x92 0xf0

The Mitutoyo motion controller 102 and the Mitutoyo frame 103 can optionally support additional axes, for example, dual X, dual Y, dual Z and one or more rotary axes. Mitutoyo CMM systems 100 enable execution of full functionality part inspection programs. Exemplary full functionality includes inter alia unknown scanning functionality, Phi-z plane scanning, and R-Z plane scanning.

### Section 1.2 Hexagon CMM System

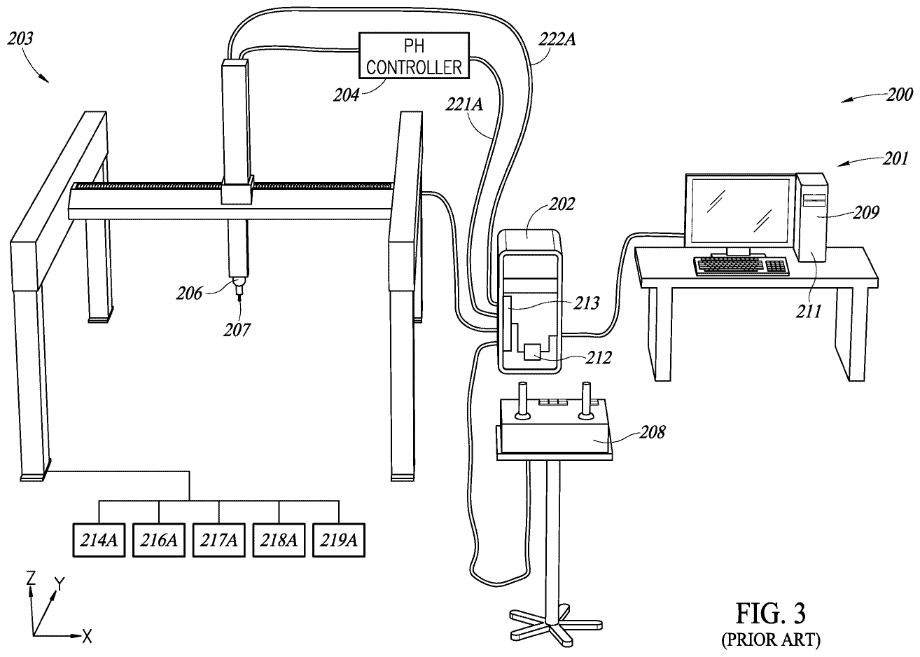

FIG. 3 shows a Hexagon CMM system 200 including a Hexagon client workstation 201, a Hexagon motion controller 202, a Hexagon frame 203 and a Probe Head (PH) controller 204 for positioning a probe head 206 to a Cartesian and/or polar destination along X, Y, and Z frame axes. The Hexagon frame 203 is exemplified by a gantry-type frame. The probe head 206 is fitted interchangeable sensing apparatus 207. The Hexagon CMM system 200 includes a joystick 208 for manual operation.

Exemplary Hexagon CMM systems 200 include inter alia
1) Global S https://www.hexagonmi.com/products/coordinate-measuring-machines/bridge-cmms/global-s
2) Global Classic https://www.hexagonmi.com/en-GB/products/coordinate-measuring-machines/bridge-cmms/entry-level-cmms/global-lite

The Hexagon client workstation 201 runs Hexagon MPPE client software 209. The Hexagon MPPE client software 209 includes a Hexagon driver set for issuing Hexagon MPPE native motion controller commands to the Hexagon motion controller 202 and receiving Hexagon MPPE native motion controller feedback messages therefrom. The Hexagon client workstation 201 and the Hexagon motion controller 202 communicate over a TCPIP or RS-232 communication link. Presently available Hexagon MPPE client software 209 includes inter alia pc-dmis, quindos, inspire, and the like. Hexagon releases software updates on a regular basis. Hexagon MPPE native motion controller commands and Hexagon MPPE motion controller feedback messages are typically in ASCII format. The Hexagon client workstation 201 stores and executes Hexagon MPPE part inspection programs 211 for inspecting parts.

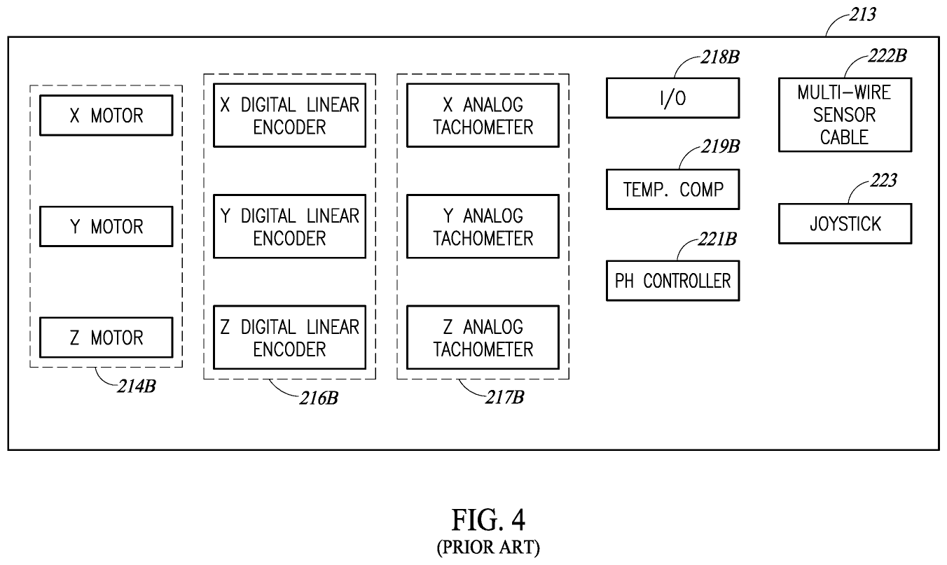

The Hexagon motion controller 202 has Hexagon firmware and/or motion controller software 212 and a Hexagon external connection board 213 (see FIG. 4).

The Hexagon frame 203 includes the following components:
X, Y and Z motors 214A for positioning the probe head 206 along the X, Y and Z frame axes
X, Y, and Z digital linear encoders 216A for position feedback of the probe head 206 along the X, Y and Z frame axes
X, Y and Z analog tachometers 217A for velocity feedback of the probe head 206 along the X, Y and Z frame axes
I/O (limit switches, emergency stop, air pressure sensor, and the like) 218A
And optional temperature compensation sensors 219A

The components 214A, 216A, 217A, 218A and 219A correspondingly terminate at D-type connectors 214B, 216B, 217B, 218B and 219B for connection on the Hexagon external connection board 213.

The PH controller 204 includes a cable 221A terminating at a D-type connector 221B for connection on the Hexagon external connection board 213.

The sensing apparatus 207 includes a multi-wire sensor cable 222A terminating at a D-type connector 222B for connection on the Hexagon external connection board 213.

The joystick 208 terminates at a D-type connector 223 for connection on the Hexagon external connection board 213.

Hexagon MPPE client software 209 is in bidirectional communication with the Hexagon motion controller 202. The Hexagon motion controller 202 is in uni- or bi-directional communication with the sensing apparatus 207 depending on the type of sensing apparatus 207. Hexagon MPPE client software 209 has a predetermined list of MPPE native motion controller commands for executing MPPE part inspection programs, and a predetermined list of MPPE native motion controller feedback messages. MPPE native motion controller feedback messages can be classified into at least three feedback message types as follows: First, motion controller command acknowledgements. Second, I/O feedback messages. And third, sensing apparatus feedback messages. Hexagon MPPE client software 209 sends ASCII MPPE native motion controller commands to the Hexagon motion controller 202 and receives ASCII MPPE Hexagon motion controller feedback messages therefrom.

An exemplary Hexagon MPPE native motion controller command PROBE TO for moving the sensing apparatus 207 to X=100, Y=100 and Z=100 and being ready for sensing thereat is: PROBE 289.01284, 332.12926, −375.10372, 0.000000, 0.000000, 1.000000 and its Hexagon MPPE native motion controller feedback message is: POINT 289.012898, 332.129391, −374.005046, 0.000000, 0.000000, 0.000000, 1.000000, 0.000000, 0.000000

The Hexagon motion controller 202 and the Hexagon frame 203 can optionally support additional axes, for example, dual X, dual Y, dual Z and one or more rotary axes. Hexagon CMM systems 200 enable execution of full functionality part inspection programs. Exemplary full functionality includes inter alia hole finder.

Section 1.3 CMM System with Renishaw's UCC Universal CMM Controller

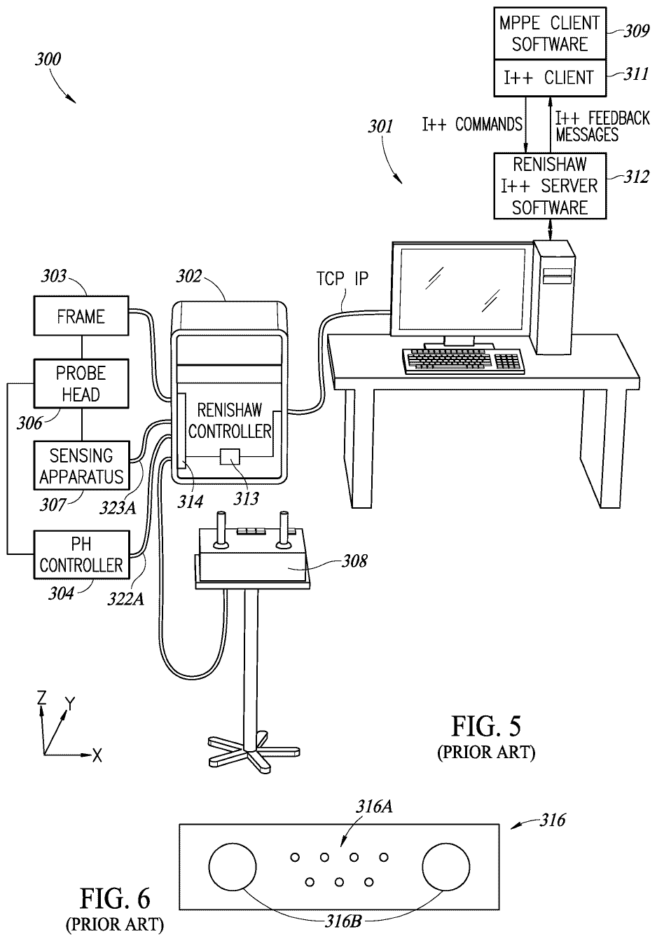

FIG. 5 shows a CMM system 300 including a client workstation 301, a Renishaw UCC universal CMM controller 302 (hereinafter referred to as Renishaw motion controller), a frame 303 and a Probe Head (PH) controller 304 for positioning a probe head 306 along X, Y, and Z frame axes to a Cartesian and/or polar destination. The probe head 306 is fitted with interchangeable sensing apparatus 307. The CMM system 300 includes a joystick 308 for manual operation.

Renishaw motion controllers 302 are based on I++ protocol and require I++ client software and I++ server software installed on the client workstation 301. Renishaw motion controllers 302 can operate with a wide range of MPPE client software 309 with an embedded I++ client software 311. An alphabetical list of MPPE client software vendors includes inter alia Autodesk's PowerINSPECT, Innovmetric's Polyworks, LKMetrology's Camio Studio, Hexagon's pc-dmis, quindos, inspire, etc, Mitutoyo's Mcosmos, Siemens' NX CMM, TouchDMIS, Verinsurf, and the like. Alternatively, Renishaw motion controllers 302 can be supplied with Renishaw's own brand of MPPE client software marketed under the brand name Modus.

Renishaw motion controllers 302 are supplied together with Renishaw I++ server software 312. Renishaw motion controllers 302 have Renishaw firmware and/or motion controller software 313 and a Renishaw external connection board 314. The Renishaw motion controller 302 is designed to receive input from X, Y and Z digital linear encoders and X, Y, and Z analog tachometers similar to Hexagon motion controllers. Further information controllers is regarding Renishaw motion available at online http://www.renishaw.com/en/controllers-10494.

The Renishaw external connection board 314 employs a D-type connector 316 for connection to a motor and an analog tachometer in unison (see FIG. 6). The D-type connector's central pins 316A are employed for analog tachometer input and its lateral pins 316B are employed for motor output.

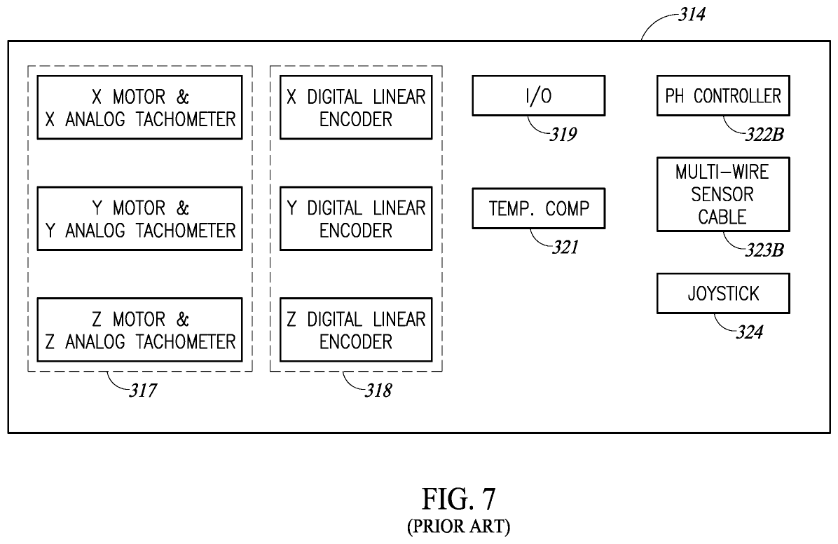

The Renishaw external connection board 314 is now described with reference to FIG. 7:

Three D-type connector array 317 for connection to X motor and X analog tachometer, Y motor and Y analog tachometer, and Z motor and Z analog tachometer.

Three D-type connector array 318 for connection to X digital linear encoder, Y digital linear encoder and Z digital linear encoder.

D-type connector 319 for connection to a frame's I/O (limit switches, emergency stop, air pressure sensor, and the like).

D-type connector 321 for connection to a frame's temperature compensation sensors.

The PH controller 304 includes a cable 322A terminating at a D-type connector 322B on the Renishaw external connection board 314.

The sensing apparatus 307 includes a multi-wire sensor cable 323A terminating at D-type connector 323B on the Renishaw external connection board 314.

The joystick 308 terminates at a D-type connector 324 for connecting to Renishaw external connection board 314.

Operation of the Renishaw motor controller 302 is now described with reference to the MPPE native motion controller command PROBE TO for moving the sensing apparatus 307 to X=100, Y=100 and Z=100 and being ready for sensing thereat and its MPPE native motion controller feedback message as follows:
MPPE client software 309 from different MPPE client software vendors send different MPPE native motion controller commands PROBE TO to their respective embedded I++ client software 311. Their embedded I++ client software 311 sends the same I++ command PROBE TO to the Renishaw I++ server software 312 as follows:

### PtMeas(X(468.123394), Y(−232.560521), Z(−613.898851)), IJK(0.000633, 0.001496, 0.999999)

The Renishaw I++ server software 312 sends Renishaw native motion controller commands to the Renishaw motion controller 302. On the sensing apparatus 307 reaching the intended destination, the Renishaw motion controller 302 sends a Renishaw native motion controller feedback message to the Renishaw I++ server software 312. The Renishaw I++ server software 312 sends the same I++ feedback message to the embedded I++ client software 311 as follows:

### #X(468.124433), Y(−232.555355), Z(−612.660248), IJK(0.000640, 0.001480, 0.999999)

The embedded I++ client software 311 sends a MPPE native motion controller feedback message to the MPPE client software 309. Embedded I++ client software 309 from different MPPE client software vendors send different MPPE native motion controller acknowledgments to their respective MPPE client software 309. Accordingly, MPPE client software (Mitutoyo MPPE client software, Hexagon MPPE client software, and the like) receives their respective MPPE native motion controller acknowledgments as described hereinabove with reference to Section 1.1 and Section 1.2 respectively.

Renishaw motion controllers 302 are employed for both setting up new CMM systems by frame manufacturers providing complete CMM systems and, in the case of a motion controller hardware failure, retrofitting existing CMM systems by CMM retrofitting companies. Retrofitting includes purchasing I++ client software for its existing MPPE client software or replacing its existing MPPE client software to a different MPPE client software including I++ client software. In both cases, a CMM user may face backwards incompatibility issues, may lose inspection capabilities and may have to update or re-write its part inspection programs.

Renishaw motion controllers 302 can be readily employed for setting up new CMM systems with Hexagon frames and replacing Hexagon motion controllers since both Renishaw motion controllers and Hexagon motion controllers are designed to receive input from X, Y and Z digital linear encoders and X, Y, and Z analog tachometers. In the case of integrating with a Mitutoyo motion controller either in a new Mitutoyo CMM system or retrofitting an existing Mitutoyo CMM system, wire-to-board connectors have to be replaced by D-type connectors. Additionally, adapters are required to convert a) analog input from Mitutoyo's X, Y and Z analog linear encoders 117A to digital linear encoder input and b) digital input from Mitutoyo's X, Y, and Z digital motor encoders 118A to analog tachometer input.

Section 1.4 CMM System with Applicant's EasyCMM™ I++ Server Software

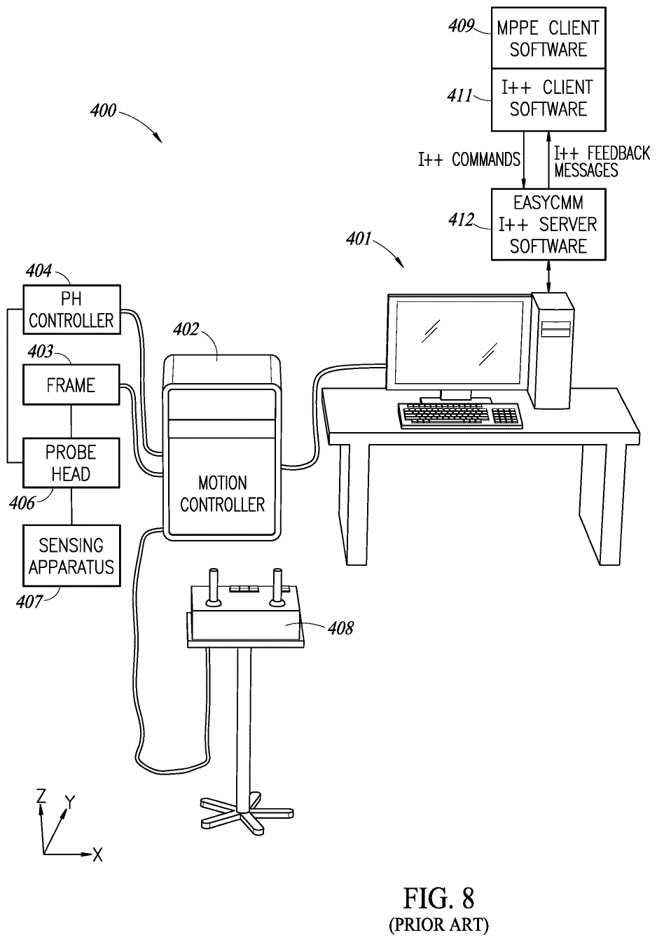

FIG. 8 shows a CMM system 400 including a client workstation 401, a motion controller 402 and a frame 403, and a Probe Head (PH) controller 404 for positioning a probe head 406 to a Cartesian and/or polar destination along X, Y, and Z frame axes. The probe head 406 is fitted with interchangeable sensing apparatus 407. The CMM system 400 includes a joystick 408 for manual operation. The client workstation 401 is installed with MPPE client software 409 with embedded I++ client software 411. The motion controller 402, the frame 403 and the MPPE client software 409 can be from the same CMM equipment vendor or different CMM equipment vendors. The CMM system 400 also includes Applicant's I++ server software 412 originally branded under the trademark EasyCMM™ installed on the client workstation 401. For further information regarding Applicant's EasyCMM™ I++ server software 412, reference is made to www.easycmm.com. Applicant's EasyCMM™ I++ server software 412 requires a CMM user to purchase I++ client software 411 for embedding in its MPPE client software 409 in a similar manner as deployment of a Renishaw motion controller.

Applicant's EasyCMM™ I++ server software 412 can be employed with MPPE client software from a wide range of MPPE client software vendors providing I++ client software. An alphabetical list of MPPE client software vendors includes inter alia Autodesk's PowerINSPECT, Innovmetric's Polyworks, LKMetrology's Camio Studio, Hexagon's pc-dmis, quindos, inspire, etc, Mitutoyo's Mcosmos, Siemens' NX CMM, TouchDMIS, Verinsurf, and the like. Applicant's EasyCMM™ I++ server software 412 can be employed with a motion controller from a range of motion controller vendors arranged in alphabetical order: Hexagon, LK, Mitutoyo, Pantec and Zeiss.

The Applicant's EasyCMM™ I++ server software 412 mediates between the MPPE client software 409 with its embedded I++ client software 411 and the motion controller 402. The communication between the MPPE client software 409 with its embedded I++ client software 411 and Applicant's EasyCMM™ I++ server software 412 is the same as between the MPPE client software 309 with its embedded I++ client software 311 and Renishaw I++ server software 312.

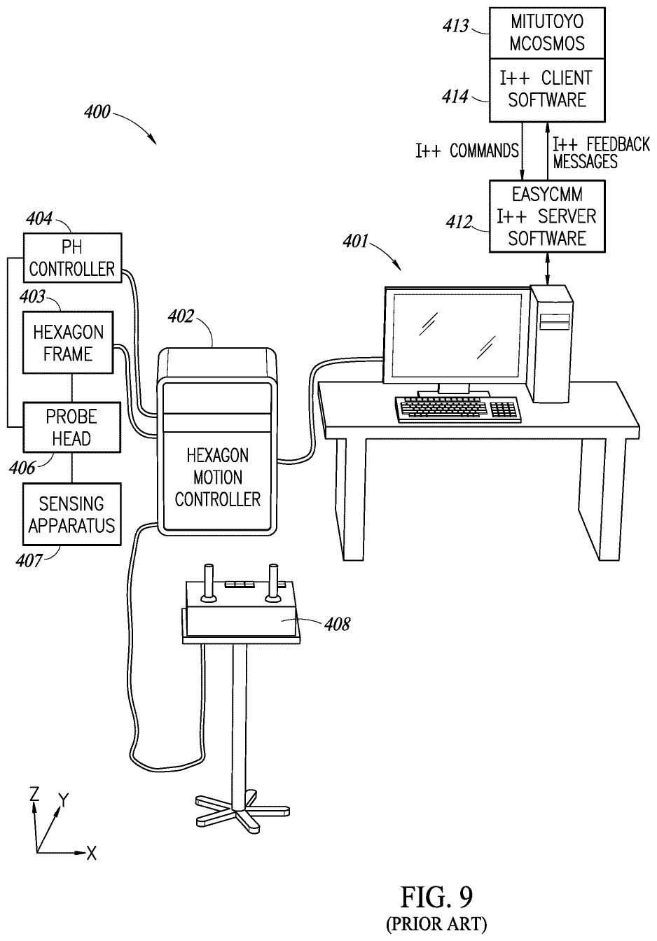

FIG. 9 shows a CMM system 400 including a Mitutoyo client workstation 401, a Hexagon motion controller 402, and a Hexagon frame 403. The Mitutoyo client workstation 401 is installed with Mcosmos MPPE client software 413 and its embedded Mcosmos I++ client software 414. Operation of the Applicant's EasyCMM™ I++ server software 412 is now described with reference to the Mcosmos MPPE native motion controller command PROBE TO for moving sensing apparatus 407 to X=100, Y=100 and Z=100 and being ready for sensing thereat and its Mcosmos MPPE native motion controller feedback message as follows:
Step 1: Mcosmos MPPE client software's embedded I++ client software 414 sends I++ command #X(468.124433), Y(−232.555355), Z(−612.660248) to Applicant's EasyCMM™ I++ server software 412
Step 2: Applicant's EasyCMM™ I++ server software 412 sends the Hexagon MPPE native motion controller command
   PROBE 289.01284, 332.12926, −375.10372, 0.000000, 0.000000, 1.000000 to the Hexagon motion controller 402.
Step 3: The Hexagon motion controller 402 parses the Hexagon MPPE native motion controller command for execution on Hexagon frame 403 and, on the sensing apparatus 407 reaching the intended destination, the Hexagon motion controller 402 sends the Hexagon MPPE native motion controller feedback message
   POINT 289.012898, 332.129391, −374.005046, 0.000000, 0.000000, 0.000000, 1.000000, 0.000000, 0.000000 to Applicant's EasyCMM™ I++ server software 412
Step 4: Applicant's EasyCMM™ I++ server software 412 sends I++ feedback message IJK(0.000640, 0.001480, 0.999999) to Mcosmos MPPE client software's embedded I++ client software 414

Thus, Applicant's EasyCMM™ I++ server software 412 provides I++ connectivity from the Mitutoyo client workstation's perspective and emulates Hexagon MPPE client software from the Hexagon motion controller's perspective. Accordingly, Applicant's EasyCMM™ I++ server software 412 enables CMM users to use Mcosmos part inspection programs on Hexagon motion controllers/frames.

### Section 2: Motion Controller Apparatus of Present Invention

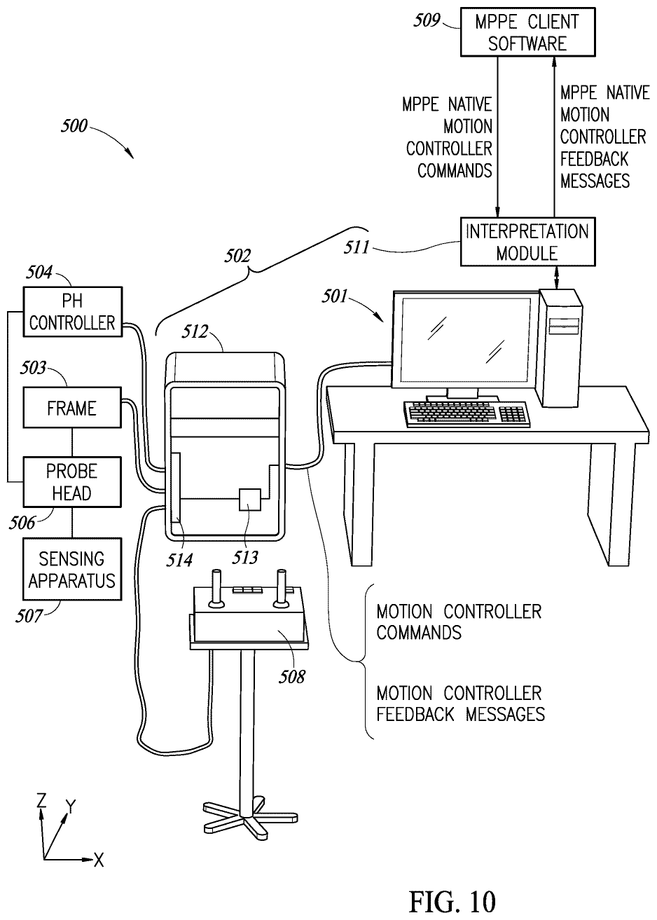

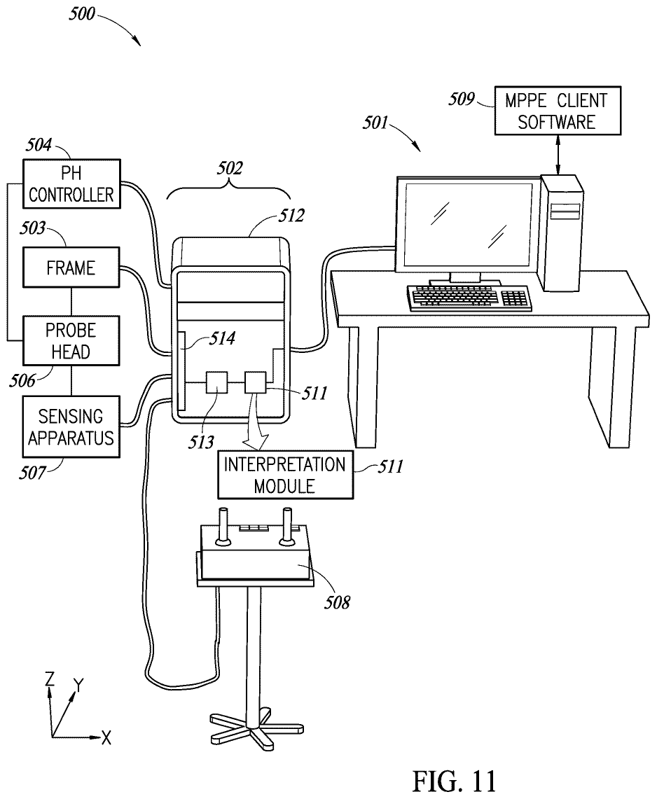

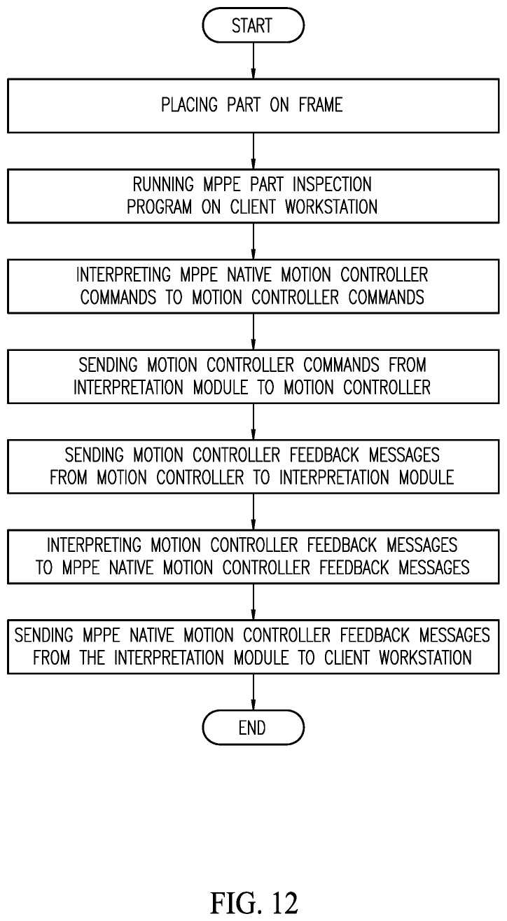

FIG. 10 and FIG. 11 show a CMM system 500 including a client workstation 501, motion controller apparatus 502, a frame 503, and a Probe Head (PH) controller 504 for positioning a probe head 506 to a Cartesian and/or polar destination along X, Y, and Z frame axes. The probe head 506 is fitted with interchangeable sensing apparatus 507. The CMM system 500 includes a joystick 508 for manual operation.

The client workstation 501 is installed with MPPE client software 509 from at least one MPPE client software vendor from a wide range of MPPE client software vendors. The CMM system 500 is similar to the CMM system 300 and the CMM system 400 insofar the client workstation 501 can be preferably installed with a wide range of at least two MPPE client software 509. An alphabetical list of MPPE client software vendors includes inter alia Autodesk's PowerINSPECT, Innovmetric's Polyworks, LKMetrology's Camio Studio, Hexagon's pc-dmis, quindos, inspire, etc, Mitutoyo's Mcosmos, Siemens' NX CMM, TouchDMIS, Verinsurf, and the like.

The CMM system 500 differs from the CMM system 300 and the CMM system 400 insofar as the client workstation 501 does not necessarily have to support I++ protocol for communication with the motion controller apparatus 502. In other words, the client workstation 501 can be installed with MPPE client software without embedded I++ client software. Neither does the motion controller apparatus 502 necessarily have to support I++ server software as opposed to the Renishaw motion controller 302.

The frame 503 can be supplied from a wide range of frame manufacturers. The frame manufacturers may adopt either Mitutoyo's approach of X, Y and Z analog linear encoders and X, Y, and Z digital motor encoders or Hexagon's approach of X, Y, and Z digital linear encoders and X, Y, and Z analog tachometers. Alternatively, frame manufacturers may adopt an analog approach of analog linear encoders and analog tachometers or a digital approach of digital linear encoders and digital motor encoders.

The motion controller apparatus 502 includes an interpretation module 511 and a motion controller 512. The interpretation module 511 can be installed either on the client workstation 501 (see FIG. 10) or the motion controller 512 (see FIG. 11). The interpretation module 511 can be implemented in the motion controller 512 as either firmware or a software module.

The interpretation module 511 includes a predetermined list of motion controller commands corresponding to a predetermined list of MPPE native motion controller commands and a predetermined list of motion controller feedback messages corresponding to a predetermined list of MPPE native motion controller feedback messages. For the purpose of clarity, the predetermined list of motion controller commands and the predetermined list of motion controller feedback messages are not a MPPE client software vendor's native motion controller commands and native motion controller feedback messages, respectively. The interpretation module 511 interprets MPPE native motion controller commands to motion controller commands and motion controller feedback messages to the MPPE native motion controller feedback messages. The interpretation module 511 can be configured to interpret MPPE native motion controller commands of one or more MPPE client software releases of the same MPPE client software.

The interpretation module 511 can also support I++ protocol similar to the Renishaw motor controller 302 and Applicant's EasyCMM™ I++ server software 409, thereby requiring installation of embedded I++ client software. The motion controller apparatus 502 can include an installation wizard for assisting configuring the interpretation module 511 to an intended MPPE client software 509.

The motion controller 512 includes firmware and/or motion controller software 513 and a connection board 514 for electrical connection to the frame 503. The motion controller 512 parses motion controller commands and motion controller feedback messages for enabling execution of MPPE part inspection programs on the frame 503 irrespective of its frame vendor. The connection board 514 can be an external connection board or an internal connection board. The connection board 514 can be implemented in one of three implementations as follows:

Universal implementation configured for electrical connection to any frame irrespective of frame vendor. In the universal implementation, the connection board 514 includes all connectors of Mitutoyo's internal connection board and external connection board, Hexagon's external connection board, Renishaw's external connection board, and the like.

Vendor specific implementation configured for electrical connection to a frame of a particular CMM system vendor, for example, Mitutoyo, Hexagon, and the like, or a particular frame vendor only. In the case of being Mitutoyo specific, a connection board 514 includes the connectors of both Mitutoyo's internal connection board 113 and external connection board 114.

Renishaw-like implementation having the same connectors as the Renishaw external connection board 314. The connection board 514 also includes D-connectors for being connected to the sensing apparatus 507.

Operation of the motion controller apparatus 502 is now described with reference to a Mitutoyo client workstation 501 and the Mcosmos MPPE native motion controller command PROBE TO for moving sensing apparatus 507 to X=100, Y=100 and Z=100 and being ready for sensing thereat and its corresponding MPPE native motion controller feedback message.
Step 1: The Mcosmos MPPE client software 509 sends the Mcosmos MPPE native motion controller command
   0x01 0x12 0xE2 0x01 0x04 0x00 0x00
   0x00 0x00 0x00 0x64
   0x00 0x00 0x00 0x64
   0x00 0x00 0x00 0x64
   0x00 0x00 0x00 0x00
   0x00 0x00 0x00 0x00
   0x00 0x00 0x36 0x65 0xc4
   to the interpretation module 511.
Step 2: The interpretation module 511 interprets the Mcosmos MPPE native motion controller command to its corresponding motion controller command

### PTP/e (X, Y, Z) 100, 100, 100

and sends it to the motion controller 512.
Step 3: The motion controller 512 parses the motion controller command for execution and, on the sensing apparatus 507 reaching the intended destination, the motion controller 512 sends a motion controller feedback message to the interpretation module 511. The motion controller feedback message is a dedicated interrupt callback function. On receiving the dedicated interrupt callback function, the interpretation module 511 reads the measured values directly from the motion controller 512.
Step 4: The interpretation module 511 interprets the motion controller feedback message to its corresponding Mcosmos MPPE client software native motion controller feedback message
   0x00 0x00 0x00 0x25 Oxde 0x72 0x00 0xb9 Oxce 0xf3 0x00 0x3f 0xbb 0x4d 0x00 0xa3 0x0d 0x4a 0xd7 0xa3 0x0d 0x4a 0xd7 0x1b 0xbc 0x92 0xf0 and sends it to the Mcosmos MPPE client software 509.

Motion controller apparatus 502 can be deployed to retrofit a Mitutoyo CMM system 100's motion controller, a Hexagon CMM system 200's motion controller, a Renishaw motion controller 302, and the like. Motion controller apparatus 502 enables customizing a CMM system with MPPE client software from one CMM equipment vendor with a frame from another CMM equipment vendor. Motion controller apparatus 502 enables unrestricted usage of a part inspection program irrespective of its software version.

While the invention has been described with respect to a limited number of embodiments, it will be appreciated that many variations, modifications, and other applications of the invention can be made within the scope of the appended claims.

1. Motion controller apparatus configured for communication with a client workstation and electrical connection with a frame vendor's frame to set up a Coordinate Measuring Machine (CMM) system including a probe head and interchangeable sensing apparatus for inspecting a part,
the frame configured to be fitted with the probe head, the frame having:
i) X, Y, and Z motors for positioning the probe head along X, Y and Z frame axes,
ii) X, Y and Z linear encoders for position feedback of the probe head along the X, Y and Y frame axes, and
iii) X, Y and Z velocity feedback devices for velocity feedback of the probe head along the X, Y, and Z frame axes,
the client workstation being installed with a Measurement Part Program Execution (MPPE) client software vendor's MPPE client software without I++ client software, the client workstation capable to run a MPPE part inspection program for inspecting the part,
the MPPE client software having:
i) a predetermined list of MPPE native motion controller commands for executing MPPE part inspection programs, and
ii) a predetermined list of MPPE native motion controller feedback messages including motion controller command acknowledgements, I/O feedback messages and sensing apparatus feedback messages,
the motion controller apparatus comprising:
(a) an interpretation module having:
i) a predetermined list of motion controller commands corresponding to the predetermined list of MPPE native motion controller commands, and
ii) a predetermined list of motion controller feedback messages corresponding to the predetermined list of MPPE native motion controller feedback messages; and
(b) a motion controller in communication with said interpretation module and including a connection board for electrical connection to the frame,
the motion controller apparatus being configured for:
said interpretation module interpreting the MPPE part inspection program's MPPE native motion controller commands to their corresponding motion controller commands,
said motion controller parsing said motion controller commands for controlling the frame,
said motion controller parsing motion controller feedback messages from the frame,
said interpretation module interpreting said motion controller feedback messages to their corresponding MPPE native motion feedback messages,
said interpretation module sending said MPPE native motion feedback messages to the client workstation, thereby enabling execution of the MPPE part inspection program on the part irrespective of the frame vendor.

2. Apparatus according to claim 1 wherein the client workstation is installed with MPPE client software of at least two MPPE client software vendors.

3. Apparatus according to claim 1 wherein said interpretation module is implemented in said motion controller.

4. Apparatus according to claim 1 wherein said interpretation module is client software for installation on the client workstation.

5. Apparatus according to claim 1 wherein said motion controller is configured for electrical connection to:
i) the frame's X, Y and Z motors,
ii) the frame's X, Y and Z linear encoders wherein the linear encoders are analog linear encoders, and
iii) the frame's X, Y and Z velocity feedback devices wherein the velocity feedback devices are digital motor encoders.

6. Apparatus according to claim 1 wherein said motion controller is configured for electrical connection to:
i) the frame's X, Y and Z motors,
ii) the frame's X, Y and Z linear encoders wherein the linear encoders are digital linear encoders, and
iii) the frame's X, Y and Z velocity feedback devices wherein the velocity feedback devices are analog tachometers.

7. Apparatus according to claim 1 wherein said motion controller is configured for electrical connection to:
i) the frame's X, Y and Z motors,
ii) the frame's X, Y and Z linear encoders wherein the linear encoders are either analog linear encoders or digital linear encoders, and
iii) the frame's X, Y and Z velocity feedback devices wherein the velocity feedback devices are either digital motor encoders or analog tachometers.

8. A method of operation for motion controller apparatus configured for communication with a client workstation and electrical connection with a frame vendor's frame to set up a Coordinate Measuring Machine (CMM) system including a probe head and an interchangeable sensing apparatus for inspecting a part, the method of operation comprising the steps of:
a) providing a frame configured to be fitted with a probe head, the frame having:
i) X, Y, and Z motors for positioning the probe head along X, Y and Z frame axes,
ii) X, Y and Z linear encoders for position feedback of the probe head along the X, Y and Y frame axes, and
iii) X, Y and Z velocity feedback devices for velocity feedback of the probe head along the X, Y, and Z frame axes;
b) providing sensing apparatus on the probe head;
c) providing a client workstation installed with a Measurement Part Program Execution (MPPE) client software vendor's MPPE client software without I++ client software, the client workstation capable to run a MPPE part inspection program for inspecting the part,
the MPPE client software having:
i) a predetermined list of MPPE native motion controller commands for executing MPPE part inspection programs, and
ii) a predetermined list of MPPE native motion controller feedback messages including motion controller command acknowledgements, I/O feedback messages and sensing apparatus feedback messages;
d) providing a motion controller apparatus including:
i) an interpretation module having:
a predetermined list of motion controller commands corresponding to the predetermined list of MPPE native motion controller commands, and
a predetermined list of motion controller feedback messages corresponding to the predetermined list of MPPE native motion controller feedback messages, and
ii) a motion controller in communication with the interpretation module and including an electrical connection board for connecting to the frame;
e) placing the part on the frame;
f) running the MPPE part inspection program on the client workstation;
g) interpreting the MPPE native motion controller commands to motion controller commands;
h) sending the motion controller commands from the interpretation module to the motion controller;
i) sending motion controller feedback messages from the motion controller to the interpretation module;
j) interpreting the motion controller feedback messages to MPPE native motion controller feedback messages; and
k) sending the MPPE native motion controller feedback messages from the interpretation module to the client workstation, thereby enabling execution of the MPPE part inspection program on the part irrespective of the frame vendor.

9. The method according to claim 8 wherein the client workstation is installed with MPPE client software of at least two MPPE client software vendors.

10. The method according to claim 8 wherein the interpretation module is implemented in the motion controller.

11. The method according to claim 8 wherein the interpretation module is client software for installation on the client workstation.

12. The method according to claim 8 wherein the motion controller is configured for electrical connection to:
i) the frame's X, Y and Z motors,
ii) the frame's X, Y and Z linear encoders wherein the linear encoders are analog linear encoders, and
iii) the frame's X, Y and Z velocity feedback devices wherein the velocity feedback devices are digital motor encoders.

13. The method according to claim 8 wherein the motion controller is configured for electrical connection to:
i) the frame's X, Y and Z motors,
ii) the frame's X, Y and Z linear encoders wherein the linear encoders are digital linear encoders, and
iii) the frame's X, Y and Z velocity feedback devices wherein the velocity feedback devices are analog tachometers.

14. The method according to claim 8 wherein the motion controller is configured for electrical connection to:
i) the frame's X, Y and Z motors,
ii) the frame's X, Y and Z linear encoders wherein the linear encoders are either analog linear encoders or digital linear encoders, and
iii) the frame's X, Y and Z velocity feedback devices wherein the velocity feedback devices are either digital motor encoders or analog tachometers.
